(19) United States
(12) Patent Application Publication
(10) Pub. No.: US 2004/0032859 A1
(43) Pub. Date: Feb. 19, 2004

(54) Managing a remote resource

(76) Inventor: Kai X. Miao, Boonton, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/222,508

(22) Filed: Aug. 15, 2002

(51) Int. Cl. H04L 12/66; H04J 1/02

(52) U.S. Cl. 370/352; 370/493

(57) ABSTRACT

A method and apparatus to manage a remote resource over a network is described.

### BACKGROUND

Voice over packet (VOP) technology is typically directed to communicating voice signals over a packet network. VOP networks may provide, for example, many of the same telephony services offered by conventional circuit-switched networks, e.g., the Public Switched Telephone Network (PSTN). Examples of these services may include call completion, call forwarding, call conferencing and so forth. VOP networks, however, typically utilize call terminals that are far more sophisticated than traditional telephones. Many of these call terminals are essentially computers. VOP networks may therefore use these enhanced call terminals to provide a host of new telephony services that otherwise may not have been possible or feasible with conventional PSTN networks and equipment.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention.

FIG. 2 is a block diagram of a system in accordance with one embodiment of the invention.

FIG. 3 is a block flow diagram of operations performed by a Resource Management Module (RMM) in accordance with one embodiment of the invention.

### DETAILED DESCRIPTION

Embodiments of the invention may comprise a method and apparatus to manage a resource over a network, such as a VOP network. In one embodiment of the invention, a call connection may be created between a first device and a second device. A request to execute a resource on the second device may be received from the first device. The resource may be executed at the second device in accordance with the request.

For example, assume a first person (“caller”) establishes a call connection with a second person (“callee”) using a VOP network. During the conversation, the caller may want to execute a resource stored at the callee's call terminal, or a computer connected to the call terminal. The resource may be, for example, an application to display an image or video clip. The caller may send control information to the callee's call terminal to cause the application to display the image or video clip. The term “control information” as used herein may refer to any data or signals representing instructions or commands to manage a resource. The control information may be communicated to the callee's computer or call terminal using the VOP protocol used for the call connection. The callee's computer or call terminal would receive the control information, and then process the resource request accordingly.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

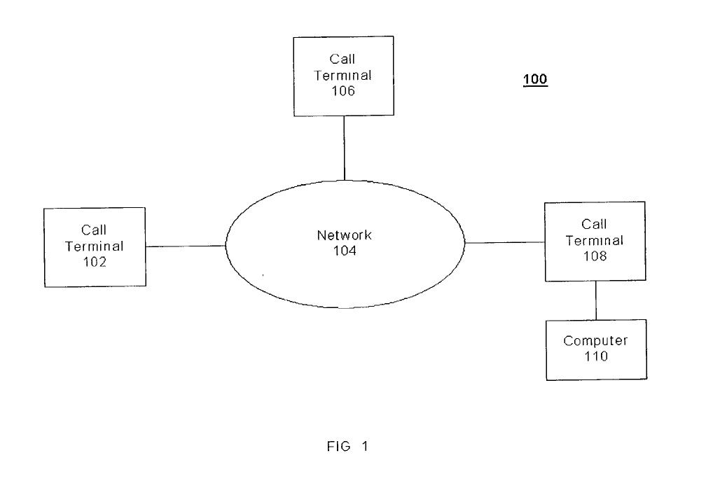

Referring now in detail to the drawings wherein like parts are designated by like reference numerals throughout, there is illustrated in FIG. 1 a system suitable for practicing one embodiment of the invention. FIG. 1 is a block diagram of a system 100. System 100 may comprise, for example, call terminals 102, 106 and 108, all connected by a network 104. Call terminal 108 may be connected to a computer 110.

Examples of a call terminal may include any device capable of communicating audio and tone signals over a network. A call terminal may comprise, for example, a conventional telephone set, a packet telephony telephone, a computer equipped with a speaker and microphone, a wireless telephone, a portable or handheld computer equipped with a transceiver and modem, a personal digital assistant (PDA) and so forth.

In one embodiment of the invention, call terminal 102 is a conventional telephone set configured to operate with the PSTN. In this embodiment, call terminal 102 does not have a processor, memory or display capabilities. In this embodiment, call terminal 102 may initiate execution of a resource on another call terminal, but may not have another call terminal execute a resource on itself since it lacks a sufficient processing system.

In one embodiment of the invention, call terminal 106 is a computer equipped with a microphone, speaker and call processing software. In this embodiment, call terminal 106 may be configured to operate as a packet telephony telephone as well as perform conventional computer tasks, e.g., executing software applications.

In one embodiment of the invention, call terminal 108 is a packet telephony telephone. In this embodiment of the invention, call terminal 108 is configured to communicate voice signals over a packet network to another call terminal, e.g., call terminal 102 and/or call terminal 106. It is worthy to note that voice signals communicated between call terminal 102 and call terminals 106 and/or 108 may need to be converted from one communication format to another, e.g., packet-switched to circuit-switched signals and vice-versa. Call terminal 108 is also connected to computer 110, which includes a processing system configured with a processor, memory, a keyboard, screen and hard drive, and further may be capable of storing and executing software applications.

Network 104 may comprise, for example, a packet network. In one embodiment of the invention, network 104 may operate in accordance with, for example, one or more Internet protocols such as the Transmission Control Protocol (TCP) as defined by the Internet Engineering Task Force (IETF) standard 7, Request For Comment (RFC) 793, adopted in September, 1981, and the Internet Protocol (IP) as defined by the IETF standard 5, RFC 791, adopted in September, 1981, both available from “www.ietf.org”, although the embodiments of the invention are not limited to this context. Network 104 may also operate in accordance with one or more protocols to communicate VOP packets representing audio, voice or tone information. In one embodiment of the invention, for example, network 104 may operate in accordance with the International Telecommunications Union (ITU) Recommendation H.323 titled “Packet-based Multimedia Communication Systems,” published in November 2000 and available from “www.itu.int” (“H.323 Specification”); the IETF Proposed Standard RFC 2543 titled “SIP: Session Initiation Protocol,” published in March 1999, and available from “www.ictf.org” (“SIP Specification); or the IETF Proposed Standard RFC 3015 titled “Megaco Protocol Version 1.0,” published in November 2000, and also available from “www.ietf.org” (“Megaco Specification”). Although specific examples are discussed herein, it may be appreciated that the embodiments of the invention are not limited in this context. Further, network 104 may also include circuit-switched technologies and appropriate interfaces to packet network technologies.

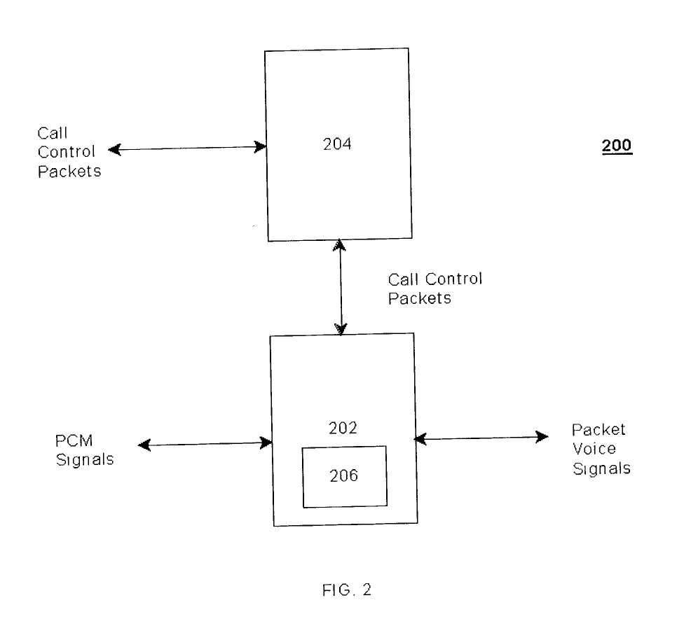

FIG. 2 illustrates a VOP system suitable for use with one embodiment of the invention. FIG. 2 is a block diagram of a system 200. System 200 may comprise part of, for example, system 100 shown in FIG. 1. System 200 may comprise VOP elements 202 and 204. Element 202 may further include element 206.

Element 202 of system 200 may comprise, for example, a media gateway that may operate to convert a conventional telephony call to a packet telephony call or VOP call. Gateway 202 may also perform the functions of a conferencing server to connect one or more streams of telephone calls together to form an audio conference. In one embodiment, gateway 202 may receive signals from a circuit-switched network and convert them to packet voice signals. An example of a circuit-switched network may be the PSTN. An example of signals communicated via a circuit-switched network may comprise Pulse Code Modulation (PCM) signals. The conversion to packets may be made in accordance with, for example, the TCP/IP Specification, SIP Specification, H.323 Specification, Megaco Specification and others. Gateway 202 may communicate both call control packets and packet voice signals through other components of system 200 until the packets reach their intended destination, e.g., a call terminal connected to system 200.

Element 204 of system 200 may comprise a media gateway controller or gatekeeper to perform conventional call processing functions, such as address translation, admission control, call control signaling, call authorization, call management and so forth in accordance with the SIP Specification, Megaco Specification or H.323 Specification, for example. Controller 204 may communicate with gateway 202 via call control packets to perform such call processing functions. In one embodiment of the invention, controller 204 may provide address and routing information to communicate packets through system 200 to the destination call terminal, such as call terminals 106 and/or 108. In this embodiment, controller 204 may also connect a call between packet telephony equipped call terminals, e.g., between call terminals 106 and 108.

In one embodiment of the invention, gateway 202 may also include a Resource Management Module (RMM) 206. RMM 206 may manage resources located at a call terminal or a computer connected to a call terminal. The term “resource” as used herein may refer to any software or hardware accessible by a call terminal. In one embodiment of the invention, RMM 206 may include functionality that may be implemented as software executed by a processor, hardware circuits or structures, or a combination of both. The processor may be a general-purpose or dedicated processor, such as a processor from the family of processors made by Intel Corporation, Motorola Incorporated, Sun Microsystems Incorporated and others. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components.

In operation, RMM 206 may manage resource requests made from call terminals 102, 106 or 108. For example, RMM 206 may permit an operator of one call terminal to execute a software application or multimedia application on the call terminal of another operator during a telephone call.

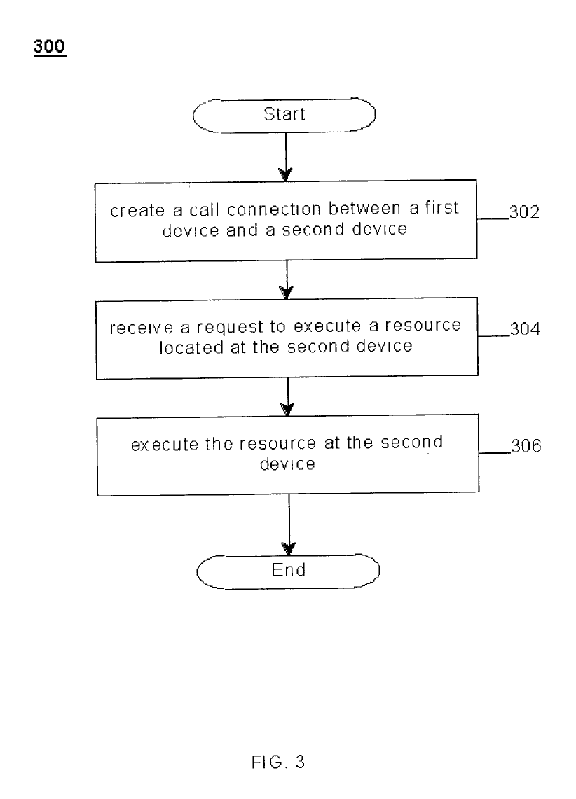

The operations of systems 100 and 200 may be further described with reference to FIG. 3 and accompanying examples. Although FIG. 3 as presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 3 is a block flow diagram of the operations performed by a resource management module in accordance with one embodiment of the invention. In one embodiment of the invention, this or other modules may refer to the software and/or hardware used to implement the functionality for one or more embodiments as described herein. In this embodiment of the invention, this or other modules may be implemented as part of a system, such as system 200. It can be appreciated that this functionality, however, may be implemented by any device, or combination of devices, located anywhere in a communication network and still fall within the scope of the invention.

FIG. 3 illustrates a programming logic 300 for a resource management module in accordance with one embodiment of the invention. Programming logic 300 may be directed to managing a resource over a network, such as a VOP network. A call connection may be created between a first device and a second device at block 302. In one embodiment, the call connection may be a VOP call connection. A request to execute a resource located at the second device may be received at block 304. The resource may be executed at the second device at block 306.

In one embodiment of the invention, the request may comprise control information. The control information may be inserted into a VOP packet, also referred to herein as a control packet. The control packet may be sent to the second device. The second device may extract the control information and execute the resource accordingly.

In one embodiment of the invention, the resource may be executed by determining whether the resource is located at the second device. The resource may be sent or transferred to the second device if not already stored there. The control packet may be sent to the second device, where it may extract the control information and execute the transferred resource.

In one embodiment of the invention, an intermediate device such as RMM 206 of gateway 202 may determine whether the resource is located at the second device. In this embodiment, the intermediate device may send a resource status request to the second device. The resource status request may request the second device to provide a status check as to whether the resource is located there. The second device may check for the presence of the resource, and send a resource status response to the intermediate device. The resource status response may comprise, for example, a flag indicating the presence or absence of the resource. The intermediate device may use the resource status response to determine whether the resource is located at the second device.

In one embodiment of the invention, the intermediate device may maintain a list of resources for each device on the network, including the second device. In this embodiment, the intermediate device may search the list of resources for the second device to make this determination. The list of resources for each device may be updated periodically in a number of different ways. If the resource is not on the list of resources for the second device, the intermediate device may transfer the resource to the second device. The second device may then execute the resource per the control information embedded in the control packet.

In one embodiment of the invention, the intermediate device may forward the request to execute a resource to the second device without determining whether the resource is located at the second device. In this embodiment, the second device would receive the request to execute the resource, and determine whether the resource is located in memory or its hard drive, or in the computer connected to the call terminal. If the resource is not present at either the call terminal or connected computer, the call terminal may send a resource request to the intermediate device or some other server to request transfer of the resource to the second device. The intermediate device or some other server may receive the resource request and transfer the resource in accordance with the request.

The operation of systems 100 and 200, and the processing logic shown in FIG. 3, may be better understood by way of example. Assume a caller creates a call connection between two call terminals terminals, e.g., call terminals 106 and 108. The call connection may be set up via gateway 202 of system 200, for example. RMM 206 of gateway 202 may enable the operator of the first call terminal to send control information to the second call terminal of another operator, and request that the second call terminal execute a resource. If the second call terminal has the resource, the second call terminal may then execute the resource in accordance with the request. If the second call terminal does not have the resource, the resource may be transferred to the second call terminal from another device, e.g., gateway 202 or another server accessible via network 104 or system 200.

In one embodiment of the invention, the second call terminal may initiate the transfer of the resource upon receiving the control information from the first call terminal. In another embodiment of the invention, an intermediate device may intercept the control information, determine whether the resource is available at the second call terminal, and transfer the resource to the second call terminal if the resource is currently not located at the second call terminal. An example of an intermediate device may be gateway 202.

In one embodiment of the invention, the resource may be a software application or multimedia file. The resource may reside in the memory or hard drive of the second call terminal, or a computer connected to the second call terminal. In this manner, a caller may be able to execute multimedia information for the operator of the second call terminal. Any software applications or multimedia files may be executed in this manner. For example, the control information may include a request to activate an application to display any visual effects, such as pictures, images, videos, graphics, slideshows, icons, animations and so forth. In another example, the control information may include a request to activate an application to play any audio effects, such as tones, voice clips, music, sound effects and so forth. It can be appreciated that the embodiments are not limited in this context.

In one embodiment of the invention, control information may be communicated between call terminals using the VOP protocol used to convey conventional voice signals in a packet telephony telephone session. Many VOP protocols reserve fields for application specific control information. For example, the Megaco Specification reserves one or more fields for elements described as “Event” and “Signal “descriptors for use with particular applications. The Event and Signal descriptors may be categorized and defined in a particular package to support a particular multimedia application. A number of application specific Event and Signal packages have been already predefined, such as a DTMF detection package, Real Time Transport Protocol (RTP) package, a T.38 package, a modem package, and so forth.

In one embodiment of the invention, the reserved fields for a particular VOP protocol may be defined for conveying control information in accordance with the principles described herein. For example, a series of activation signals may be defined for a particular implementation. Table 1 shown below may provide an example of such a series.

TABLE 1

| Activation | | | |
|---|---|---|---|
| Signal | Resource Identifier | File Name | Result |
| F1 | Video Application | Smilingbuddha.wav | Play Filename |
| F2 | Video Application | Talkingface.wav | Play Filename |
| F3 | Audio Application | Snoring.avi | Play Filename |
| F4 | Internet Browser | www.cnn.com | Retrieve Web |
| | | | Page |

Table 1 illustrates a list of Activation Signals, Resource Identifier, Filenames and Results for a given implementation. The Activation Signal may refer to the input sequence used to initiate execution of a resource. The Resource is the particular resource to be executed. The Filename is the name of the file that is to be executed by the resource. The Results indicate the action requested by the Activation Signals.

For example, during the course of the telephone call, assume the operator of the first call terminal may not appreciate a comment by the operator of the second call terminal. To emphasize his dissatisfaction, he may press the “F2” key on the keyboard of call terminal 106. Call terminal 106 may intercept the signals generated by pressing the “F2” key and recognize the signal as one of the activation signals. Call terminal 106 may prompt the operator for a filename to be executed, and the operator may enter the filename “Talkingface.wav”. Once call terminal 106 receives the filename, the activation signal, resource identifier and filename may be used to create a control packet in accordance with the currently used VOP protocol. The control packet may be sent to call terminal 108 for execution.

An intermediate device may intercept the control packet sent from call terminal 106. An example of the intermediate device may be gateway 202. RMM 206 may intercept the control packet, and determine that the control packet includes a request to execute a resource on the second device, e.g., computer 110 connected to call terminal 108. In one embodiment of the invention, RMM 206 may determine whether the resource is located at computer 110, either through querying computer 110 or checking a stored resource list for computer 110. If the resource is not already located at computer 110, RMM 206 may initiate transfer of the resource to computer 110. It is worthy to note that the resource may include one or both of the resource identifier “video application” and filename “Talkingface.wav”. RMM 206 may then forward the control packet to call terminal 108.

Call terminal 108 may receive the control packet and extract the control information from the packet. Call terminal 108 may interpret he control information as a request to execute a resource on computer 110. Call terminal 108 may cause computer 110 to execute the resource having the resource identifier “video application” to play the file having the filename “Talkingface.wav”. Computer 110 may then execute the video application, and a video of a talking face may be displayed on the monitor for computer 110.

In an attempt to placate the operator of call terminal 106, the operator of call terminal 108 may press the key “F1”. Similar to the operations provided above, call terminal 108 may send a control packet having the activation signal “F1”, the resource identifier for “video application” and filename for “Smilingbuddha.wav” to call terminal 106. RMM 206 of gateway 202 may forward the control packet and possibly the resource to call terminal 106. Call terminal 106 may then execute the video application, and a graphic of a smiling Buddha may be displayed on the display of call terminal 106.

In another example, the operator of call terminal 106 may want to retrieve or execute a file that is accessible by call terminal 108 but not currently residing on call terminal 108 or computer 110. For example, the operator of call terminal 106 may want computer 110 to retrieve or execute a file located on another server or computer accessible by computer 110 over a network, e.g., the Internet or World Wide Web (WWW). During the course of the telephone call, the operator of call terminal 106 may press the “F4” key to begin this process. Call terminal 106 may intercept the signals generated by pressing the “F4” key and recognize the signal as one of the activation signals. Call terminal 106 may prompt the operator for an Internet address or Uniform Resource Locator (URL), and the operator may enter the URL “www.cnn.com”. Once call terminal 106 receives the URL, the activation signal, resource identifier and URL may be used to create a control packet in accordance with the currently used VOP protocol. The control packet may be sent to call terminal 108 for execution.

The intermediate device may intercept the control packet sent from call terminal 106. RMM 206 may intercept the control packet, and determine that the control packet includes a request to execute a resource on computer 110 connected to call terminal 108. In one embodiment of the invention, RMM 206 may determine whether the resource is located at computer 110, either through querying computer 110 or checking a stored resource list for computer 110. In this example, the resource may be an Internet browser application. If the resource is not already located at computer 110, RMM 206 may initiate transfer of the resource to computer 110. It is worthy to note that the resource may include either the Internet Browser or URL. For example, the URL may identify a web page stored in a local cache on the network or computer 110, in which case there may be no need to download a copy of the web page and deliver it to computer 110. In another example, the intermediate device may access and retrieve the web page associated with the URL on behalf of computer 110, and then transfer it to computer 110 from the intermediate device. This may be particularly appropriate, for example, if computer 110 is behind a firewall and therefore cannot access the Internet or WWW. RMM 206 may then forward the control packet to call terminal 108.

Call terminal 108 may receive the control packet and extract the control information from the packet. Call terminal 108 may interpret he control information as a request to execute a resource on computer 110. Call terminal 108 may cause computer 110 to execute the resource having the resource identifier “Internet Browser” to retrieve the web page associated with the URL “www.cnn.com”. Computer 110 may then execute the Internet Browser, retrieve the web page transferred from the intermediate device, and display the web page on the monitor for computer 110. Alternatively, computer 110 may execute the Internet Browser, connect to the web server hosting “www.cnn.com”, and retrieve the appropriate web page for display by the monitor for computer 110.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to manage a resource over a network, comprising:
creating a call connection between a first device and a second device;
receiving a request to execute a resource located at said second device; and
executing said resource at said second device.

2. The method of claim 1, wherein said call connection is created in accordance with a voice over packet (VOP) protocol.

3. The method of claim 1, wherein said request comprises control information carried by a VOP packet.

4. The method of claim 1, wherein said executing comprises sending said request to said second device.

5. The method of claim 1, wherein said executing comprises:
determining whether said resource is located at said second device;
sending said resource to said second device in accordance with said determination; and
sending said request to said second device.

6. The method of claim 1, wherein said determining comprises:
sending a resource status request to said second device;
receiving a resource status response from said second device; and
determining whether said resource is located at said second device using said resource status response.

7. The method of claim 1, wherein said determining comprises:
searching a list of resources located at said second device; and
determining whether said resource is located at said second device in accordance with said search.

8. The method of claim 7, wherein said list of resources is automatically updated on a periodic basis.

9. The method of claim 1, wherein said executing comprises:
receiving a resource request from said second device; and
sending said resource to said second device.

10. The method of claim 1, wherein said resource comprises a software application.

11. The method of claim 1, wherein said resource comprises a multimedia application.

12. An article comprising:
a storage medium;
said storage medium including stored instructions that, when executed by a processor, result in managing a resource over a network by creating a call connection between a first device and a second device, receiving a request to execute a resource located at said second device, and executing said resource at said second device.

13. The article of claim 12, wherein the stored instructions, when executed by a processor, further result in creating said call connection in accordance with a VOP protocol.

14. The article of claim 12, wherein the stored instructions, when executed by a processor, further result in said execution by sending said request to said second device.

15. The article of claim 12, wherein the stored instructions, when executed by a processor, further result in said execution by determining whether said resource is located at said second device, sending said resource to said second device in accordance with said determination, and sending said request to said second device.

16. The article of claim 15, wherein the stored instructions, when executed by a processor, further result in said determining by sending a resource status request to said second device, receiving a resource status response from said second device, and determining whether said resource is located at said second device using said resource status response.

17. The article of claim 15, wherein the stored instructions, when executed by a processor, further result in said determining by searching a list of resources located at said second device, and determining whether said resource is located at said second device in accordance with said search.

18. The article of claim 17, wherein the stored instructions, when executed by a processor, further result in automatically updating said list of resources on a periodic basis.

19. The article of claim 12, wherein the stored instructions, when executed by a processor, further result in said executing by receiving a resource request from said second device, and sending said resource to said second device.

20. A system, comprising:
a computing platform adapted to manage resources over a network;
said platform being further adapted to creating a call connection between a first device and a second device, receiving a request to execute a resource located at said second device, and executing said resource at said second device.

21. The system of claim 20, wherein said platform is further adapted to determining whether said resource is located at said second device, sending said resource to said second device in accordance with said determination, and sending said request to said second device.

22. The system of claim 21, wherein said platform is further adapted to perform said determining by sending a resource status request to said second device, receiving a resource status response from said second device, and determining whether said resource is located at said second device using said resource status response.

23. The system of claim 21, wherein said platform is further adapted to perform said determining by searching a list of resources located at said second device, and determining whether said resource is located at said second device in accordance with said search.

24. The system of claim 20, wherein said platform is further adapted to perform said executing by receiving a resource request from said second device, and sending said resource to said second device.
